(19) United States
(12) Patent Application Publication
(10) Pub. No.: US 2004/0040472 A1
(43) Pub. Date: Mar. 4, 2004

(54) Method of recycling cement kiln dust

(76) Inventor: Donald Everett, Sylvania Township, OH (US)

Correspondence Address: HARNESS, DICKEY & PIERCE, P.L.C., P.O. BOX 828, BLOOMFIELD HILLS, MI, 48303, US

(21) Appl. No.: 10/234,486

(22) Filed: Sep. 3, 2002

(51) Int. Cl. C04B 2/10; C04B 7/26

(52) U.S. Cl. 106/739; 106/751

(57) ABSTRACT

A method of recycling cement kiln dust (CKD) generated during the direct manufacturing of cement. The recycling process utilizes the creation of a flowable slurry comprising CKD, a process aid, optionally other raw materials and water. The process aid is selected from the group consisting of sucrose, raffinose, lignin, methylglucopyranoside, lactose, fructose, sodium polyphosphate, trehalose and mixtures thereof, and is added to increase the flowability of the slurry and thereby simplifying recycling. The slurry is reintroduced into the cement kiln, wherein it is burned to create cement clinkers, that are subsequently ground to the fineness required for hardening when reacted with water.

### FIELD OF THE INVENTION

The present invention relates generally to a process for recycling cement kiln dust generated during the manufacturing of cement. More specifically, this invention relates to the preparation of a flowable slurry combining cement kiln dust generated during manufacturing with a process aid for recycling cement kiln dust for cement remanufacture thereof.

### BACKGROUND OF THE INVENTION

Cement kiln dust (CKD) is the particulate matter carried from the feed end of a cement kiln by the exhaust gasses, and is primarily raw materials that have been partially calcinated. CKD is a major problem at many wet cement manufacturing plants as the dust is generated in large quantities and is often not suitable for direct return to the cement-producing process as a feed, except in relatively small amounts, often because of the incompatibility of the dust with the process, or because of limitations of the process equipment. It is estimated that wasting levels in wet kilns vary between 5 and 25% of the kilns finished product (clinker) on a mass basis. Since large quantities of dust cannot be returned directly to the kiln in all cases, that material must be disposed in some manner. Beneficial uses have been suggested, but the amounts of dust so used are relatively small. Frequently, dust that cannot be directly returned or reused is discarded in on-site landfills. Such disposal methods are inherently unsatisfactory because they involve wasting a material for which significant processing and handling costs and effort have been incurred. In addition, as environmental regulations have matured, the costs and problems of disposal have become more onerous, and continued disposal of kiln dust has become ever less desirable and more expensive.

The recycling of CKD back into the manufacturing of cement is relatively old in the art. U.S. Pat. No. 4,402,891 issued to inventor Kachinski teaches of adding water to CKD in a carbon dioxide atmosphere to reduce the alkalinity of the resulting slurry and to aid pelletizing for use of the material as a fertilizer. Alkalies are not removed, and the material is not suitable for return to a cement-making process.

U.S. Pat. No. 5,374,310 issued to Bunce, et al., teaches of the use of a silicon containing product resulting from the hydrolysis of chlorosilicon by-product as materials for cement production. However, when such materials are added to a clay slurry for use in cement manufacture, a thick, non-flowable paste forms which prevents further downstream processing, especially when small amounts of water are used.

The use of other alkaline materials such as other chlorosilicon manufacturing by-products and CKD in the manufacturing of cement would also be useful, but unfortunately, these materials too would suffer from the disadvantage that they form thick pastes that are difficult to manage unless large amounts of water are used. It is therefore the clear objective of the present invention in providing for the recycling of CKD to create a flowable slurry suitable for wet cement remanufacture in the combination of CKD by utilizing process aid which inhibit the formation of thick pastes, that yields a high reutilization percentage while maintaining a flowability which can be reasonably accommodated during the recycling process.

### SUMMARY OF THE INVENTION

It is therefore the clear objective of the present invention in providing for a means of recycling CKD in utilizing a process aid in combination with the CKD to provide for a flowable slurry suitable for cement remanufacture by reintroduction into the wet cement manufacturing process.

The recycling process disclosed here within for reintroducing cement kiln dust into the cement manufacturing process utilizes a flowable slurry comprising CKD, a process aid, optionally other raw materials as dictated by process chemistry, and water. Specifically, the process disclosed in the present invention makes use of a slurry composition utilizing process aids disclosed in U.S. Pub. No. 2002/0033121 to inventor Marko, under a license by Dow Corning Corporation. Ideally, the process aid is selected from the group consisting of sucrose, raffinose, lignin, methylglucopyranoside, lactose, fructose, sodium polyphosphate, trehalose and mixtures thereof, simplifying the recycling of CKD.

The process aid inhibits the formation of thick pastes that result when the CKD and, optionally, other raw materials, are mixed with water, providing for the optimal slurry composition which provides for high product reutilization while maintaining a flowability which can be reasonably accommodated during the recycling process.

### DETAILED DESCRIPTION OF THE INVENTION

As disclosed in U.S. Pub. No. 2002/0033121, The present invention utilizes a process for preparing a flowable slurry comprising a CKD material, a process aid, optionally clay and water. The alkaline materials useful herein for the present invention comprise the calcium rich material of cement kiln dust (CKD) as generated during the direct manufacture of cement products. The process aid inhibits the formation of thick pastes that result when the alkaline material and, optionally, other raw materials, are mixed with water.

Generally, cements manufactured by the wet process are made by mixing suitable raw materials with water, burning at suitable temperatures to effect clinker formation, and grinding the resulting clinkers to the fineness required for hardening by reaction with water. The burning operation generates the cement kiln dust, and while the actual composition is not critical to the invention, typical chemical compositions for CKD (from wet plants) are in the range of about 15 to 55 wt. % CaO, 10 to 35 wt. % SiO.sub.2, 2 to 10 wt. % Al.sub.20.sub.3, 1 to 6 wt. % Fe.sub.20.sub.3, 1 to 11 wt. % MgO, 0.2 to 2 wt. % K.sub.20, 0.05 to 1.0 wt. % Na.sub.20, and 0.1 to 5 wt. % SO.sub.3. (as measured by x-ray diffractions.)

The CKD is typically added to the slurry of the present invention in amounts of between 30 to 70% of the total slurry by weight, although smaller percentages are also intended to fall within the scope of the present invention.

The process aids used in the present invention are selected from the group consisting of sucrose, raffinose, lignin, methylglucopyranoside, lactose, fructose, sodium polyphosphate, trehalose and mixtures thereof. These materials are all known in the art and readily commercially available. Preferably, the process is selected from the group 5 consisting of sucrose, lignin, fructose and mixtures thereof. It should be noted that the use of precursors for these process aids as well as compositions containing these process aids are within the scope of this invention.

The amount of process aid used in the present invention depends on the other components used (i.e., CKD, the other raw materials, and the water) as well as the quantities thereof. Generally, however, the process aid is used in an amount of from about 0.02 to about 10 wt. %, alternatively about 0.02 to about 5 wt. %, based on the weight of the slurry. Alternatively, the amount of process aid is within the range of about 0.05 to 1 wt. %.

The slurry of the present invention can also contain other raw materials because slurries are a feedstock for cement manufacture and incorporating the CKD into the slurry is a convenient method for introducing the CKD into the cement production process. While the type of raw materials utilized herein is not critical to the invention, typical examples include montmorillonite clay which comprises magnesium aluminum silicates suspended in water, often in suspensions of about 25-65% montmorillonite clay in water. Such clay suspensions, as well as suspensions containing other types of raw materials, are commercially available.

If used, the raw materials are usually added to the slurry of the present invention in amounts of about 1-65 wt. % clay solids, often above about 40 wt. %, alternatively above about 45 wt. %, based on the total weight of the clay solids in the slurry.

Water is also a component of the slurry. Typically it is included in the slurry in amount of from about 25 to about 70 wt. %, alternatively from about 30 to about 55 wt. % based on the weight of the slurry. Values above 70% can be used, but the volume of water that needs to be removed in the calcining process becomes so large that it is economically prohibitive to boil it away due to fuel costs.

It should be noted that CKD may make up all or only a portion of the calcium and silica requirements of the slurry. As such, calcium, iron, alumina and/or silica-containing materials can be added to the invention.

The order and method of mixing the components is not critical to the invention. For example, all of the components of the slurry can be mixed at the same time. Alternatively, the process aid can be mixed with a mixture of the water, CKD and optional other raw materials, even after a thick paste has formed. Similarly, the CKD and optional clay can be mixed with aqueous solutions of the process aid.

These materials can be mixed by conventional mixing techniques and conventional mixing equipment such as, but not limited to, rod mills, pan mills pug mills, other single or multi-shaft mixers.

When the process aids of the invention are incorporated in slurries of the materials described herein, the slurries remain flowable and, thus, processable in cement manufacturing operations. Thus, not only are there significant savings in raw material costs in wet cement manufacturing, but this process eliminates costs associated with disposing cement kiln dust.

Once mixed, the slurry is subsequently fed back into the wet cement manufacturing kiln and burned at suitable temperatures to effect clinker formation, and grinding the resulting clinkers to the fineness required for hardening when reacted with water.

What is claimed is:

1. A process for recycling cement kiln dust comprising:
recovering the cement kiln dust generated in the direct manufacturing of cement;
combining with a specified amount of water to form a flowable slurry;
combining with a process aid to increase viscosity of said slurry;
reintroducing said slurry into said cement kiln;
burning said slurry to formation of cement clinkers;
grinding said clinkers to the fineness required for hardening when reacted with water.

2. The process according to claim 1 wherein said process aid is selected from the group consisting of sucrose, raffinose, lignin, methylglucopyranoside, lactose, fructose, sodium polyphosphate, trehalose and mixtures thereof to form a flowable slurry.

3. The process according to claim 1 wherein the process aid is selected from the group consisting of sucrose, lignin, fructose and mixtures thereof.

4. The process according to claim 1, wherein other raw materials are also mixed into the slurry.

5. The process according to claim 1, wherein the amount of process aid is in the range of 0.02 to 10 wt. %.

6. The process according to claim 1, wherein the amount of process aid is in the range of 0.05 to 1 wt. %.

7. The process according to claim 1 wherein the amount of CKD is in the range of up to 70 wt %.

8. A process according to claim 4, wherein the amount of other raw materials is in the range of 1 to 65 wt %.

9. A process according to claim 4, wherein the other raw material is clay.

10. A flowable slurry comprising: 25-70 wt. % water; cement kiln dust and a process aid selected from the group consisting of sucrose, raffinose, lignin, methylglucopyranoside, lactose, fructose, sodium polyphosphate, trehalose and mixtures thereof to form a flowable slurry.
